(19) United States
(12) Patent Application Publication
(10) Pub. No.: US 2012/0157354 A1
(43) Pub. Date: Jun. 21, 2012

(54) FRICTION REDUCER

(76) Inventors: Leiming Li, Sugar Land, TX (US); Lijun Lin, Sugar Land, TX (US); Baudel William Quintero, Friendswood, TX (US); Paul R. Howard, Sugar Land, TX (US)

(21) Appl. No.: 13/316,974

(22) Filed: Dec. 12, 2011

Related U.S. Application Data
(60) Provisional application No. 61/423,834, filed on Dec. 16, 2010.

(51) Int. Cl. C09K 8/06; E21B 43/26; C09K 8/00; C09K 8/68

(52) U.S. Cl. 507/129; 507/203; 166/308.1; 507/103; 507/240; 507/268

(57) ABSTRACT

Disclosed herein is a composition comprising from about 0.1 wt % to about 50 wt % of a plant based product comprising mucilage. Methods of making the composition, a well treatment fluid comprising the composition, and methods of using the composition are also disclosed.

### CROSS REFERENCE TO RELATED APPLICATIONS

This application claims priority to and the benefit of provisional application U.S. 61/423,834, filed Dec. 16, 2010, which is hereby incorporated herein by reference in its entirety.

### BACKGROUND

The statements in this section merely provide background information related to the present disclosure and may not constitute prior art.

High friction pressure is a known operational issue in various drilling and subterranean extraction operations. High friction pressure is undesirable since it may result in high pressures in open hole sections that can exceed the fracturing pressure of the formation. Unintended fracturing during a gravel pack treatment, for example, may lead to incomplete packing and loss of gravel to the formation, ultimately impairing productivity. Friction is generated as water or other fluids flow through production piping and the like. For wells at relatively high depths, such as 20,000 ft. (6090 m), or 30,000 ft. (9144 m), excessive friction pressure can alter the well design in terms of limiting the drilled length of an horizontal zone, or in other cases limits the ability to effectively pump treatment fluids when the pumping power at the surface is otherwise limited.

Known methods to reduce friction pressure include the use of polymer-based materials including chemical additives known to reduce the friction pressure of flowing fluids. Environmental concerns, advancements in drilling equipment, and recovery techniques present an evergreen need for improvements in friction reduction during subterranean treatments.

### BRIEF DESCRIPTION OF THE SEVERAL VIEWS OF THE DRAWINGS

FIG. 1 is a graphical representation showing % drag reduction effect of 0.5%, 1%, and 2% of a plant based product comprising mucilage derived from aloe in tap water according to an embodiment of the instant disclosure, measured as a function of flow rate (kg/min) in 19 mm friction loop.

FIG. 2 is a graphical representation showing % drag reduction effect of 0.5%, 1%, and 2% of a plant based product comprising mucilage derived from aloe in tap water according to an embodiment of the instant disclosure, measured as a function of flow rate (kg/min) in 13 mm friction loop.

FIG. 3 is a graphical representation showing % drag reduction effect of 0.5%, 1%, and 2% of plant based product comprising mucilage derived from aloe in tap water according to an embodiment of the instant disclosure, measured as a function of flow rate (kg/min) in 13 mm friction loop.

FIG. 4 is a graphical representation showing % drag reduction effect of 1% plant based product comprising mucilage derived from aloe in tap water and 2 wt % KCl according to an embodiment of the instant disclosure, measured as a function of flow rate (kg/min) in 13 mm friction loop.

FIG. 5 is a graphical representation showing % drag reduction effect of a plant based product comprising mucilage derived from aloe with a stabilizer in tap water according to an embodiment of the instant disclosure, measured as a function of flow rate (kg/min) in a 13 mm friction loop.

FIG. 6 is a graphical representation showing % drag reduction effect of 0.2%, of a plant based product comprising mucilage derived from okra in tap water according to an embodiment of the instant disclosure, measured as a function of flow rate (kg/min) in a 19 mm and in a 13 mm friction loop.

FIG. 7 is a graphical representation showing % drag reduction effect of various concentrations of plant based product comprising mucilage derived from okra in tap water containing various ionic species according to an embodiment of the instant disclosure, measured as a function of flow rate (kg/min) in 13 mm friction loop.

FIG. 8 is a graphical representation showing % drag reduction effect of 0.5% plant based product comprising mucilage derived from okra in tap water containing various ionic species according to an embodiment of the instant disclosure, measured as a function of flow rate (kg/min) in 13 mm friction loop.

FIG. 9 is a graphical representation showing % drag reduction effect of 1.4% plant based product comprising mucilage derived from cactus in tap water according to an embodiment of the instant disclosure, measured as a function of flow rate (kg/min) in 19 mm and 13 mm friction loops.

FIG. 10 is a graphical representation showing % drag reduction effect of a comparative example of 0.06% guar gum in tap water measured as a function of flow rate (kg/min) in 19 mm and 13 mm friction loops.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In this detailed description, each numerical value should be read once as modified by the term “about” (unless already expressly so modified), and then read again as not so modified unless otherwise indicated in context. Also, in this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.”

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

As used herein, the new numbering scheme for the Periodic Table Groups are used as in Chemical and Engineering News, 63(5), 27 (1985).

A material is said to be “dispersible” in a liquid medium if the material is at least partially soluble in the liquid medium, i.e., does not undergo Tyndall scattering, or which forms a colloid, an emulsion, or the like.

As used herein, the term “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form the monomer. However, for ease of reference the phrase comprising the (respective) monomer or the like is used as shorthand.

As used herein the term “mucilage” refers to a naturally occurring, high-molecular-weight (i.e., 200,000 g/mol and higher), organic plant product of unknown detailed structure. The term is not to be confused with or used interchangeably with the term gum. For purposes herein, mucilage refers to the material which is closely allied to gums and pectins but which differs in certain physical properties. Gums are known to swell in water to form sticky, colloidal dispersions; pectins are known to gelatinize in water. For purposes herein mucilage may be differentiated from gums and pectins by the ability of mucilage to form slippery, aqueous colloidal dispersions when contacted with water, in contrast to gums and pectins. Mucilage is known to occur in plants and in marine sources.

As used herein the term “plant based material comprising mucilage” refers to an extract, pressing, and/or homogenate from at least one plant source comprising mucilage. Accordingly, a plant based material comprising mucilage may include any or all of an entire plant, so long at it comprises mucilage. In an embodiment, the plant based material comprising mucilage may comprise a homogenate of one or more plants.

In an embodiment, a composition comprises from about 0.1 wt % to about 50 wt % of a plant based product comprising mucilage. In an embodiment, the plant based product comprising mucilage comprises an extract, pressing, homogenate, or a combination thereof from at least one plant source.

In an embodiment, the plant based product comprising mucilage of the composition according to the instant disclosure comprises mucilage derived from an extract, pressing, homogenate, or a combination thereof, from aloe vera, Basella alba (Malabar Spinach), Cactus, Chondrus crispus (Irish moss), Dioscorea opposita (Nagaimo, Japanese Mountain Yam), Drosera (sundews), Fenugreek, Flax seed, Kelp, Liquorice root, Marshmallow, Mullein, Okra, Parthenium, Pinguicula (butterwort), Psyllium seed husks, Salvia hispanica (chia) seed, Ulmus rubra bark (slippery elm), or a combination thereof. In an embodiment, a well treatment fluid comprises the composition according to the instant disclosure. In an embodiment, the well treatment fluid is an aqueous composition which may include a solution, a suspension, an emulsion, a gel or the like.

In an embodiment, the plant based product comprising mucilage is an extract, pressing or homogenate from aloe vera, okra, cactus, or a combination thereof. In an embodiment, the “juice” from these natural plants can be extracted, filtered, and then used directly as the plant based product comprising mucilage without further purification.

In and embodiment, the well treatment fluid may be produce by combining a plant based product comprising mucilage with a fluid to produce the well treatment fluid. In an embodiment, the fluid comprises water, brine, or the like. In an embodiment, the fluid comprises fresh water, produced water, flowback water, or the like, or any mixture of them. In an embodiment, the plant based product comprising mucilage is provided as a liquid, a solid, a dehydrated solid, an emulsion, a suspension, a filtered extract, or a combination thereof, and is mixed with the fluid and optionally with other components, to produce the well treatment fluid.

In an embodiment, a well treatment fluid comprises a plant based product comprising mucilage at a concentration sufficient to produce a % drag reduction of the fluid of greater than or equal to about 10% relative to water, wherein % drag reduction (% DR) is determined using a friction loop, which is a length of pipe of a known diameter, according to the formula:

$$\% DR = \frac{Δ Pwater - Δ Pfluid}{Δ Pwater} \cdot 100$$

wherein ΔP water is the pressure differential between an inlet and an outlet of a friction loop having water flowing there-through at a temperature and a flow rate, and wherein ΔP fluid is the pressure differential between the inlet and the outlet of the friction loop having the fluid flowing there-through under the same conditions (i.e., the same temperature and flow rate) as the water.

In an embodiment, the well treatment fluid comprises from about 0.1 wt % to about 50 wt % of the plant based product comprising mucilage. In an embodiment, the well treatment fluid comprises at least about 0.5 wt %, or at least about 1 wt %, or at least about 2 wt %, or at least about 3 wt %, or at least about 4 wt %, or at least about 5 wt %, or at least about 1 Owt % of the plant based product comprising mucilage, and less than about 40 wt %, or less than about 30 wt %, or less than about 20 wt % of the plant based product comprising mucilage.

In an embodiment, the well treatment fluid may further comprise a gas, a proppant particulate, a foaming agent, a gelling agent, a pH control agent, a breaker, an oxidizing breaker, a gel stabilizer, a fluid loss control additive, a clay stabilizer, a corrosion inhibitor, a crosslinking agent, a scale inhibitors, a catalyst, a surfactant, an additional friction reducing agent, or a combination thereof.

In an embodiment, example of other friction reducing agents include polymers, including generally high molecular weight linear polymers or polymers that have been slightly crosslinked or drag reducing surfactant formulations or a combination of these. As used herein with reference to polymers, “high molecular weight” is meant to encompass those polymers having a molecular weight of from about 5 to about 25 million or more. These polymers may be pumped at low enough concentrations such that they do not significantly increase the viscosity of the fluid. Suitable polymers may include guar or a guar derived polymer. Examples of suitable synthetic polymers and copolymers include polymethylmethacrylate, polyethyleneoxide, polyacrylamide, polymethacrylamide, partially hydrolyzed polyacrylamide, cationic polyacrylamide derived polymers such as those obtained by radical polymerization of dimethylamino ethyl methacrylate (DMAEMA), 2-(methacryloyloxy)-ethyltrimethylammonium chloride (MADQUAT), methacrylamidopropyl trimethyl ammonium chloride (MAPTAC), or diallyldimethylammonium chloride (DADMAC), or anionic polymer such as polyAMPS (poly 2-acrylamido-2-methylpropane sulfonic acid), and the like.

Examples of other suitable friction reducers include polyacrylamide derivatives which may be supplied as concentrated emulsified conventional drag reducing formulations, containing around 30% of active vinyl polymer. Other polymers include high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form.

In an embodiment, the well treatment fluid may further comprise bacterial origin polymers such as xanthan, diutan, and scleroglucan, three biopolymers, may also be useful as a friction reducing agent. Such friction reducing biopolymers are described in US 2008-0026957 A1, which is herein incorporated by reference in its entirety.

The friction reducing agent may include viscoelastic surfactants (VES) or mixtures of viscoelastic surfactants, with or without other friction reducing polymers. Nonlimiting examples of suitable viscoelastic surfactant materials are described in U.S. Pat. Nos. 5,979,557 (Card et al.); 6,435,277 (Qu et al.) and 6,703,352 (Dahayanake et al.), which are each incorporated herein by reference in their entireties. The viscoelastic surfactants may include cationic surfactants, amphoteric surfactants, zwitterionic surfactants, including betaine surfactants, anionic surfactants and combinations of these.

The friction reducing fluid may comprise friction reducing surfactant formulations in combination with one or more polymeric or monomeric friction reducing enhancers. Such friction reduction enhancers and friction reduction materials are described in US 2008-0064614 A1, which is incorporated by reference herein in its entirety. Suitable friction reducing surfactants may include cationic surfactants, amphoteric surfactants, zwitterionic surfactants, anionic surfactants and combinations of these. Specific examples of suitable friction reducing surfactants, when used with a primary friction reduction enhancer, include cetyl trimethyl ammonium chloride and tallow trimethyl ammonium chloride. The polymeric friction reduction enhancers are polymers, which may be either cationic or anionic.

Optionally, a monomeric friction reduction enhancer may also be used in combination with the friction reducing surfactant. Such monomeric drag reduction enhancers are organic counter ions, and may include monomers or oligomers of the polymeric drag reduction enhancer. An example of these friction reduction enhancers is (sodium) polynaphthalene sulfonate, as the polymeric friction reduction enhancer, and (sodium) naphthalene sulfonate, as the monomeric friction reduction enhancer.

Co-surfactants, which may have slightly different chemical natures from the main surfactant, may also be used. Thus, for example, the co-surfactant may be cationic if the main surfactant is anionic. Co-solvents, such as isopropyl alcohol, glycerol, ethylene glycol, propylene glycol, ethylene glycol monomethyl ether, and ethylene glycol monobutyl ether, may also be used.

The well treatment fluid disclosed herein may be compatible with one or more heavy brines, such as seawater, NaCl, KCl, NaBr, CaBr2, CaCl2, and the like. In such instances, the friction reducing agent would not cause precipitation in such brines and still be effective as a drag reducing agent. The choice of brine can also result in an improvement of the friction reduction capability of a given friction reducer, such as the polymer or surfactant based friction reducing agents.

The well treatment fluid may be released through a friction reducing agent dispensing apparatus that locates downhole with the tubing of the well. The friction reducing agents may be released downhole from such dispensing apparatus in response to various conditions. These may include increased pressures required for circulation of fluids due to 1) changes in the fluid hydrostatic head that can be altered by means of varying brine density of reduced gravel concentration in the wellbore; 2) fluid flow rate; and 3) reduced effectiveness of the friction reducing agents pumped at the surface, which may be caused by shear induced degradation or contact with fluids being produced from the reservoir, or with solids being deposited on the wellbore face during the drilling process.

Release of the well treatment fluid downhole in accordance with the invention may result in a pressure drop (DR) of from up to 10%, 20%, 30%, 40%, 50%, 60%, 70% or more. Such percentages of friction reduction is normally estimated from measurements of pressure in the well as a comparison of the pressure differential for the friction reducing fluid (ΔP fluid) as compared to the pressure differential of brine or water (ΔP water) (as determined by similar measurements or engineering correlations) and reported according to the following formula:

$$\% Drag Reduction = \frac{Δ P water - Δ P fluid}{Δ P water} * 100 \%$$

In an embodiment, the plant based product comprising mucilage further comprises from 1 ppm to 1 wt % of a biocide, a preservative, a thermal stabilizer, or a combination thereof. In an embodiment, the biocide comprises a quaternary amine, an aldehyde, an alpha-omega aldehyde, or a combination thereof. In an embodiment, the biocide comprises glutaraldehyde.

In an embodiment, the plant based product comprising mucilage comprises a thermal stabilizer. In an embodiment, the thermal stabilizer comprises a metal selected from Groups 3-16 of the periodic table of the elements. In an embodiment, the thermal stabilizer comprises a metal salt, oxide or coordination compound comprising a Group 3 to Group 16 metal, a Group 3 to 12 metal, a Group 4 metal, or a combination thereof. In an embodiment, the thermal stabilizer comprises zirconium.

In an embodiment, the thermal stabilizer is present in the plant based product comprising mucilage at a concentration from about 1 ppm to about 1000 ppm.

In an embodiment, the well treatment fluid may comprise water and/or an organic solvent. The organic solvent may be selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibuthylether, dimethyl-formamide (DMF), dimethyl sulfoxide (DMSO), dioxane, ethanol, ethyl acetate, ethylene glycol, glycerin, heptanes, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethane, pentane, Petroleum ether (ligroine), 1-propanol, 2-propanol, pyridine, tetrahydrofuran (THF), toluene, triethyl amine, o-xylene, m-xylene, p-xylene.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes are preferred, especially d-limonene (most preferred), 1-limonene, dipentene (also known as 1-methyl-4-(1-methylethenyl)-cyclohexene), myrcene, alpha-pinene, linalool and mixtures thereof.

Further exemplary organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly (alkyl and/or aryl)ethers of polyalkylene glycols, monoalkanoate esters of glycols, monoalkanoate esters of polyalkylene glycols, polyalkylene glycol esters like poly (alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

In an embodiment, a method of treating a formation penetrated by a wellbore comprises introducing a well treatment fluid according to the present disclosure into a wellbore penetrating a subterranean formation, wherein the treatment fluid comprises from about 0.1 to about 50 wt % of the plant based product comprising mucilage.

In an embodiment, a method of fracturing a subterranean formation comprising: providing a fracturing fluid; providing a well treatment fluid that comprises a plant based product comprising mucilage according to the present disclosure, and introducing the fracturing fluid into the subterranean formation at a pressure sufficient to create or extend at least one fracture in the subterranean formation.

In an embodiment, the mucilage friction reducer may be added to the well treatment fluid continuously as the fluid was being used, e.g., on the fly. In an embodiment, the plant based product comprising mucilage may be a liquid or a solid. In an embodiment, the plant based product comprising mucilage may be added into the well treatment fluid, e.g., a fracturing fluid, in batches, or directly pumped or contacted with the well treatment fluid. In an embodiment, the plant based product comprising mucilage may comprises a concentrated plant extract, homogenate, or the like which may be subsequently diluted at a later time in the process. In an embodiment, the plant based product comprising mucilage may be provided and/or used as a split stream.

The well treatment fluid according to the present disclosure may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time.

In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

Accordingly, the present invention provides the following embodiments of the invention:

A. A composition comprising from about 0.1 wt % to about 50 wt % of a plant based product comprising mucilage.

B. The composition of Embodiment A, wherein the plant based product comprising mucilage comprises an extract, pressing, homogenate, or a combination thereof from at least one plant source, at least one marine source, or a combination thereof.

C. The composition of Embodiment A or B, wherein the plant based product comprising mucilage comprises an extract, pressing, homogenate, or a combination thereof from Aloe Vera, Basella Alba, Cactus, Chondrus crispus, Dioscorea opposita, Drosera, Fenugreek, Flax seed, Kelp, Liquorice root, Marshmallow, Mullein, Okra, Parthenium, Pinguicula, Psyllium seed husks, Salvia hispanica seed, Ulmus rubra bark, or a combination thereof.

D. The composition of Embodiment A, B, or C, comprising water or brine.

E. The composition of Embodiment A, B, C, or D, wherein the plant based product comprising mucilage is present in the composition at a concentration sufficient to achieve 10 to 80% drag reduction wherein % drag reduction, is determined according to the formula:

$$\% DR = \frac{Δ Pwater - Δ Pfluid}{Δ Pwater} \cdot 100$$

wherein % drag reduction is represented as % DR;

ΔP water is the pressure differential between an inlet and an outlet of a friction loop pipe having water flowing there-through at a temperature and a flow rate; and wherein ΔP fluid is the pressure differential between the inlet and the outlet of the same friction loop pipe having the composition flowing there-through at the same temperature and the same flow rate as the water.

F. The composition of Embodiment A, B, C, D, or E, further comprising a gas, a proppant particulate, a foaming agent, a gelling agent, a pH control agent, a breaker, an oxidizing breaker, a gel stabilizer, a fluid loss control additive, a clay stabilizer, a corrosion inhibitor, a crosslinking agent, a scale inhibitors, a catalyst, a surfactant, a preservative, a biocide, a thermal stabilizer, or a combination thereof.

G. The composition of Embodiment A, B, C, D, E, or F, further comprising from about 1 ppm to 1 wt % each of a biocide, a preservative, a thermal stabilizer, or a combination thereof.

H. The composition of Embodiment A, B, C, D, E, F, or G, wherein the biocide comprises a quaternary amine, an aldehyde, an alpha-omega di-aldehyde, or a combination thereof.

I. The composition of Embodiment A, B, C, D, E, F, G, or H, wherein the thermal stabilizer comprises a metal selected from Groups 3-16 of the Periodic Table of the Elements.

J. The composition of Embodiment A, B, C, D, E, F, G, H, or I, wherein the thermal stabilizer comprises a metal salt, oxide or coordination compound comprising a Group 3 to Group 12 metal of the Periodic Table of the Elements.

K. The composition of Embodiment A, B, C, D, E, F, G, H, I, or J, wherein the thermal stabilizer comprises zirconium.

L. A well treatment fluid comprising the composition of the Embodiment of A, B, C, D, E, F, G, H, I, J, or K.

M. A friction reducer fluid comprising the composition of the Embodiment of A, B, C, D, E, F, G, H, I, J, or K.

N. A method of treating a wellbore comprising:

introducing a well treatment fluid into a wellbore penetrating a subterranean formation, wherein the treatment fluid comprises from about 0.1 to about 50 wt % of a plant based product comprising mucilage.

O. The method of Embodiment N, wherein the treatment fluid further comprises at least one additive selected from the group consisting of: a gas, a proppant particulate, a foaming agent, a gelling agent, a pH control agent, a breaker, an oxidizing breaker, a gel stabilizer, a fluid loss control additive, a clay stabilizer, a corrosion inhibitor, a crosslinking agent, a scale inhibitors, a catalyst, a surfactant, a preservative, a biocide, a thermal stabilizer, and a combination thereof.

P. A method of fracturing a subterranean formation comprising: providing a fracturing fluid comprising from about 0.1 to about 50 wt % of a plant based product comprising mucilage and introducing the fracturing fluid into the subterranean formation at a pressure sufficient to create or extend at least one fracture in the subterranean formation.

Q. A method to produce a composition comprising:

combining a plant based product comprising mucilage with a solvent, in an amount sufficient to produce a composition comprising from about 0.1 wt % to about 50 wt % of the plant based product comprising mucilage, wherein the plant based product comprising mucilage is an extract, a pressing, a homogenate, or a combination thereof, from at least one plant source.

R. The method of Embodiment Q, wherein the at least one plant source is selected from the group consisting of: Aloe Vera, Basella Alba, Cactus, Chondrus crispus, Dioscorea opposita, Drosera, Fenugreek, Flax seed, Kelp, Liquorice root, Marshmallow, Mullein, Okra, Parthenium, Pinguicula, Psyllium seed husks, Salvia hispanica seed, Ulmus rubra bark, and a combination thereof.

S. The method of Embodiment Q or R, further comprising adding from about 1 ppm to about 1 wt % each of a biocide, a preservative, a thermal stabilizer, or a combination thereof to the composition, wherein the thermal stabilizer comprises a metal salt, oxide or coordination compound comprising a Group 3 to Group 12 metal of the Periodic Table of the Elements.

T. The method of Embodiment Q, R, or S, wherein the thermal stabilizer comprises zirconium.

### EXAMPLES

In the following examples, freshly acquired aloe vera, okra, and cactus were used, without further purification as a plant based product comprising mucilage according to embodiments of the present disclosure. For purposes herein, the extracted “juice” of a mucilage source is referred to as either the plant based product comprising mucilage derived from that particular source, e.g., the plant based product comprising mucilage derived from aloe vera, or for simplicity, may be referred to merely as the “juice” of the mucilage source, e.g., aloe vera juice. Reference made to a particular juice or extract is not an indication of how the material was produced. Accordingly, a juice may be produced by blending, pressing, extraction, mastication, or any combination thereof.

### Example 1

The aloe vera used in the following examples is commonly seen in Texas and was purchased from a local grocery store (H.E.B.). The leaves were cut off and blended in a minimal amount of water in a 1 L Waring™ blender at high speed. The liquid thus formed was filtered through a #40 mesh (0.42 mm) sieve to produce the aloe vera “juice” used in the tests.

The aloe vera residue in the sieve was weighed and compared with the initial weight of the aloe vera leaves, the net weight of the aloe vera “juice” produced in the process was then calculated. However, it is contemplated that this filtered extract could also be produced by pressing the aloe vera leaves with, for example, a juice extractor or a juice press machine to obtain the aloe vera juice.

Tap water (Sugarland, Tex.) was used as the mix water. The friction loop testing apparatus required 15 L for each fluid evaluation. The aloe vera juice was added to the tap water at a (net) concentration of 0.5 wt %, 1 wt %, and 2 wt %, respectively, based on the total amount of aloe vera plant utilized to produce the juice. The water, along with the addition of the aloe vera juice, was stirred using an overhead stirrer (SERVODYNE mixer, model 50003-30) at 1000 rpm for two minutes before being added to the friction loop hopper for evaluation.

Friction loop tests were carried out to measure the % drag reduction (% DR) of the aloe vera juice relative to pure tap water. All measurements were conducted at room temperature (RT) of about 25° C. A friction loop tester comprising a 13 mm (0.5) nominal pipe (inner diameter: 11 mm (0.43″) and a 19 mm (0.75″) nominal pipe (inner diameter: 16 mm (0.62″) (also referred to herein as a “friction loop”) was used to evaluate % drag reduction. The solution being evaluated was pumped through the friction loop at a predetermined rate (kg/min) and the pressure at the inlet of the friction loop and the pressure at the outlet of the friction loop monitored. The pressure difference (denoted as ΔP) across the friction loop, as well as the mass flow and the temperature were recorded for each fluid analyzed. Initially, the friction loop was calibrated with the tap water prior to the fluid testing and all tests were run at room temperature of about 75° F. The fluids being evaluated were prepared as described above before being added to the friction loop hopper. After the prepared fluid was added to the friction loop hopper, the differential pressure gauges were purged and the pump was primed (air expelled) prior to recording the data for the test. The percent drag reduction (% DR) is calculated using the following equation:

$$\% DR = \frac{Δ Pwater - Δ Pfluid}{Δ Pwater} \cdot 100$$

The percent drag reduction (% DR) was measured and plotted as a function of the flow rate (kg/min), which is shown in the Figures.

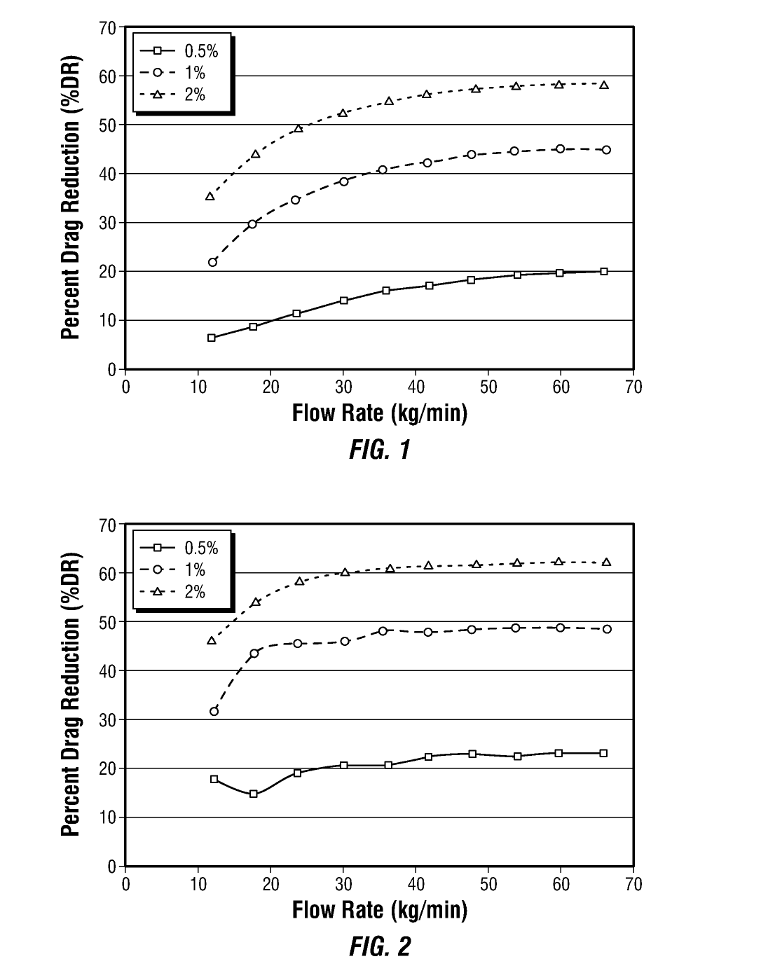

As shown in FIG. 1, the % DR values of 0.5%, 1%, and 2% of the plant based product comprising mucilage derived from aloe vera respectively, in the tap water were measured as a function of flow rate (kg/min) in a 19 mm (0.75-inch) pipe. FIG. 2 shows the % DR values of 0.5%, 1%, and 2% of the aloe vera friction reducer, respectively, in the tap water measured as a function of flow rate (kg/min) in 13 mm (0.5-inch) pipe. With the addition of 2% of the aloe vera juice, the % DR was about 60% (±5% error) in both 13 mm and 19 mm friction loops. It is expected that the % DR will further increase when the concentration of the aloe vera extract increases. The % DR values obtained from both 13 mm and 19 mm friction loops usually had the similar trend and close values.

### Example 2

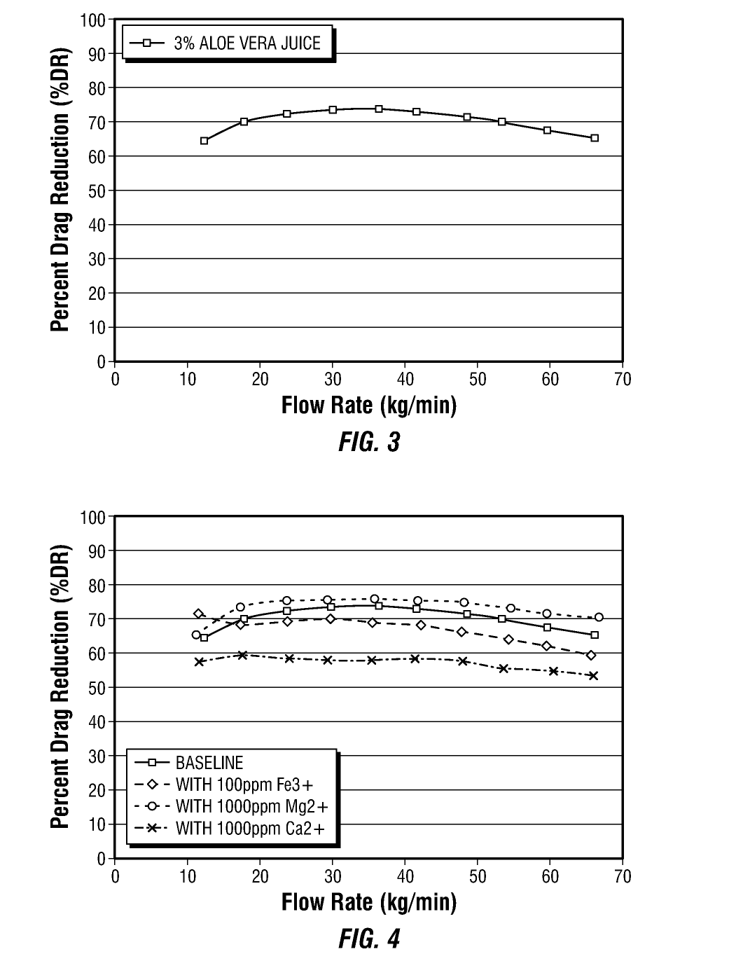

In an alternative embodiment, the aloe vera leaves were pressed with a manual hydraulic cold press juicer (Welles juice press). The extracted aloe vera fluid (the juice) was collected without further treatment. The aloe vera juice was added to 15 L of tap water at the indicated percentages (volume %), and mixed with an overhead mixer at 500 RPM for 20 minutes. After mixing, the 15 L of the fluid was filtered through a 1 mm mesh to remove the insoluble materials so that they would not block and damage the friction loop. However, it is to be understood that in actual oilfield operations, the insoluble materials may not have to be removed. Similar friction loop tests were carried out to measure the % drag reduction (% DR) of the aloe vera juice thus obtained relative to pure tap water. FIG. 3 shows the % DR value of 3% (vol. %) of the aloe vera juice in the tap water measured as a function of flow rate (kg/min) in 13 mm pipe. With the addition of 3% of the aloe vera juice, the % DR is thought capable of a % DR of at least 70% in the 13 mm friction loop.

### Example 3

In this example, the influence of a number of salts, including K⁺ (KCl), Ca²⁺, Mg²⁺, and Fe³⁺, on the friction reduction performance of the aloe vera juice is shown. The aloe vera juice was similarly obtained as in Example 2. 3% (vol. %) of the aloe vera juice was added to 15 L of the tap water with the addition of: (1) 2% KCl by weight; (2) 1000 ppm Ca²⁺ (from CaCl₂); (3) 1000 ppm Mg²⁺ (from MgCl₂); or (4) 100 ppm Fe³⁺ (from FeCl₃). The mixing procedure was similar as described above with the overhead mixer at 500 RPM for 20 minutes. FIG. 4 shows the % DR effect of 3% of the aloe vera juice in the tap water containing various types of salts. Compared with the baseline in FIG. 3 (the aloe in pure tap water without any salt) re-plotted in FIG. 4, the addition of 2% KCl (not shown, nearly overlapping the baseline), 1000 ppm Mg2+, or 100 ppm Fe3+ in the tap water did not significantly lower the % DR (±5% error) of the aloe vera juice. The % DR of the aloe in the presence of 1000 ppm Ca²⁺ was slightly reduced, yet considered to be acceptable at a 60% DR.

### Example 4

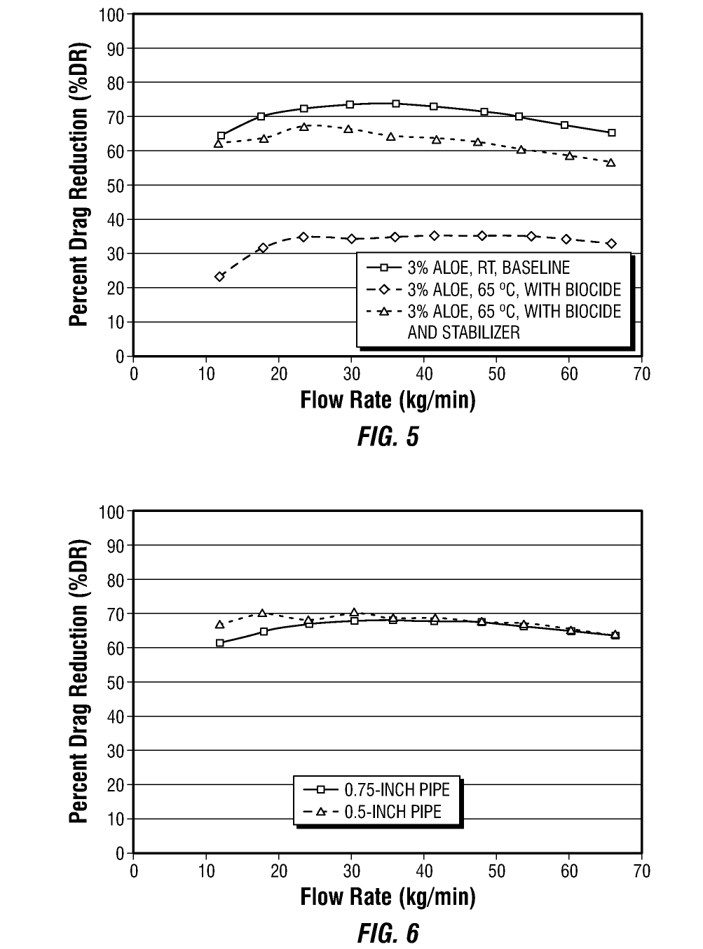

In this example, a method to improve the stability of the aloe vera juice at elevated temperature is shown. The aloe vera juice was similarly extracted with the Welles juice press as in Example 2. The juice, with the addition of glutaraldehyde biocide, was placed in a sealed glass bottle and the bottle was placed in a 65.5° C. (150° F.) water bath. The amount of the glutaraldehyde biocide was such that, when the aloe juice was added to the tap water at 3 vol. %, the concentration of the glutaraldehyde biocide was 50 ppm. The juice temperature was measured every 5 minutes until it reached 65.5° C. The aloe vera juice was then quickly cooled down to RT, and mixed in tap water at the dose of 3% (therefore the effective dose of glutaraldehyde biocide in the water was about 50 ppm), similar to Example 2. The result is shown in FIG. 5. Compared with the baseline (3% aloe vera juice in tap water at RT), the aloe vera juice showed a much lower % DR after it was heated to 65.5° C. This suggests that the aloe juice could undergo decomposition at elevated temperature, and the biocide does not appear to provide a desired amount of protection against heat.

In another test, the aloe vera juice, with the addition of glutaraldehyde biocide and a stabilizer, was placed in a sealed glass bottle and the bottle was placed in a 65.5° C. water bath. The amount of the glutaraldehyde biocide was such that, when the aloe juice was added to the tap water at 3 vol. %, the concentration of the glutaraldehyde biocide was 50 ppm.

In another embodiment, a stabilizer was used comprising zirconium derived from zirconium dichloride oxide. Other zirconium compounds, and/or other metal compounds could also be used. The amount of the stabilizer was such that, when the aloe juice was added to the tap water at 3 vol. %, the concentration of the zirconium dichloride oxide was about 40 ppm. The juice temperature was measured every 5 minutes until it reached 65.5° C. The aloe vera juice was then quickly cooled down to RT, and mixed in tap water at the dose of 3%, similar to Example 2. The result is shown in FIG. 5. Compared with the baseline (3% aloe vera juice in tap water at RT), the aloe vera juice with both the biocide and stabilizer showed only slight drop in % DR. Comparing this fluid to the aloe fluid with the biocide but without the stabilizer. Accordingly, the stabilizer provides stabilization of the aloe vera juice at elevated temperature of 65.5° C. The zirconium-containing stabilizer might have disabled the enzymes in the aloe juice, thus preventing or slowing down the breakdown of the effective friction reducing materials by the enzymes in the juice. The enzymes could come from the aloe vera itself, or from the external bacteria.

### Example 5

The okra used in the test was the young seed pods of okra purchased from a local grocery store (H.E.B. Sugarland, Tex.). The okra pods were blended in water in a Waring blender at high speed. The liquid thus formed was filtered through a #20 mesh (0.85 mm) sieve. The okra residue in the sieve was weighed, compared with the initial weight of the okra, and the net weight of the okra “juice” produced in the process was estimated.

The samples were prepared and tested as above. The okra juice was added to the tap water at the (net) concentration of 0.2%. The percent drag reduction (% DR) was measured as above and the results are shown in FIG. 6. As the data shows, the addition of 0.2% of the okra juice produced a % DR of about 60-70% in both 13 mm and 19 mm pipes.

### Example 6

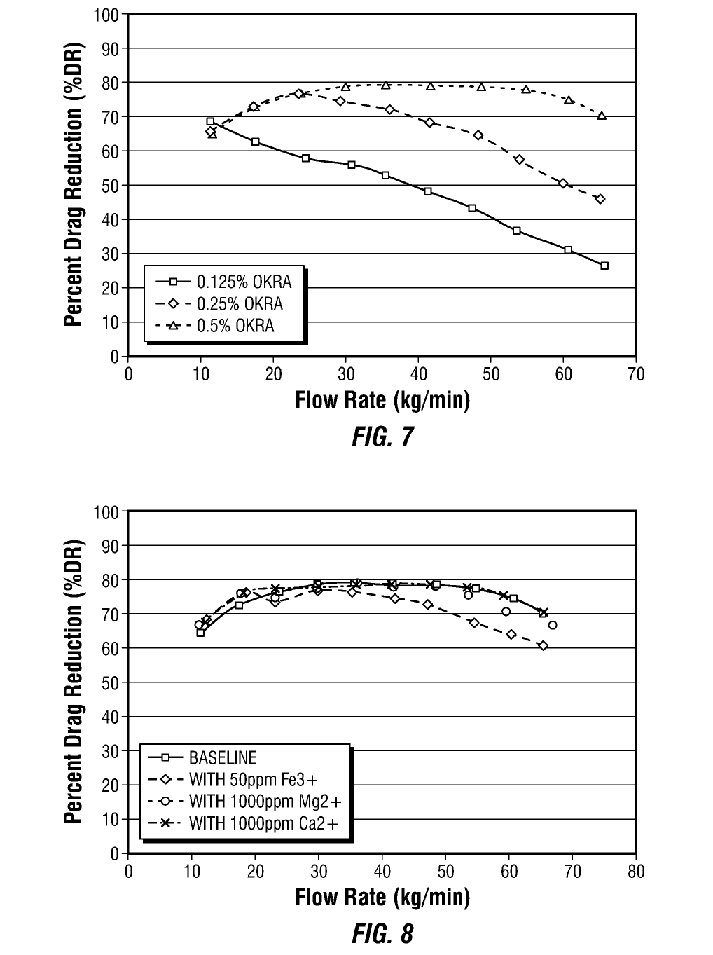

In this example, the okra dose was measured by the “raw” weight percentage i.e., the whole weight of the okra pods was used, not just the okra juice. For example, 15 L of tap water weighed about 15,000 g. If 0.5% by weight of okra was needed, 75 g of okra pods were used. The okra pods were weighed and added to a 1 L Waring blender, and tap water was added up to 0.5 L level. The okra was then blended at maximum speed for 5-10 s. The juice thus generated was added to about 14.5 L of tap water (the total volume was then 15 L), and mixed with the overhead mixer at 500 RPM for 20-30 minutes. After mixing, the 15 L of the fluid was filtered through a 1 mm mesh to remove the insoluble materials so that they would not block and damage the friction loop. In real oilfield operations, the insoluble materials may not have to be removed. Similar friction loop tests were carried out to measure the % drag reduction (% DR) of the okra fluid thus obtained relative to pure tap water. FIG. 7 shows the % DR value of 0.125% (wt %), 0.25%, and 0.5%, respectively, of the okra in the tap water measured as a function of flow rate (kg/min) in 13 mm pipe. With the addition of 0.25% or more of the okra, the % DR could reach above 70% in the 13 mm friction loop.

### Example 7

In this example, the influence of a number of salts, including K+ (KCl), Ca2+, Mg2+, and Fe3+, on the friction reduction performance of the okra extract is shown. The okra extract was similarly obtained as in example 6. About 0.5% (wt %) of the okra was used in 15 L of the tap water with the addition of: (1) 2% KCl by weight; (2) 1000 ppm Ca2+ (from CaCl₂); (3) 1000 ppm Mg2+ (from MgCl2); or (4) 50 ppm Fe3+ (from FeCl3). The mixing procedure was similar: with the overhead mixer at 500 RPM for 20 minutes. FIG. 8 shows the % DR effect of the 0.5% of the okra in the tap water containing various types of salts. Compared with the baseline (the 0.5% okra in pure tap water without any salt), the addition of 2% KCl (not shown, nearly overlapping the baseline), 1000 ppm Mg2+, or 1000 ppm Ca2+ in the tap water did not significantly lower the % DR (±5% error) of the okra. The % DR of the okra in the presence of 50 ppm Fe3+ showed slight damage when compared with the baseline.

### Example 8

In this example, the friction reduction of okra at elevated temperature was studied. 15 L of tap water weighed about 15,000 g. When 0.5% by weight of okra was needed, 75 g of okra pods were used. The okra pods were weighed and added to a 1 L Waring blender, and tap water was added up to 0.5 L level. The okra was then blended at maximum speed for 5-10 s. The fluid thus made was placed in a sealed glass bottle and the bottle was placed in a 65.5° C. water bath. The fluid temperature was measured every 5 minutes until it reached 65.5° C. The okra fluid was then quickly cooled down to RT, and mixed in 14.5 L of tap water (so the percentage of okra in water was 0.5 wt %). The % DR vs flow rate (kg/min) curve was essentially identical to that of the baseline (0.5% okra in the tap water, without thermal treatment). This suggests that okra resists the heat damage at the elevated temperature and thus the selection of mucilage for the plant based product comprising mucilage may depend on the intended end use conditions.

### Example 9

The cactus used in these tests was fresh nopalitos cactus leaves, PLU code: 4558, obtained from a local grocery store (H.E.B., Sugarland, Tex.). The leaves were blended in water in a Waring blender at high speed. The liquid thus formed was filtered through a #20 mesh (0.85 mm) sieve. The cactus residue in the sieve was weighed, compared with the initial weight of the cactus leaves, and the net weight of the nopalitos cactus “juice” produced was calculated.

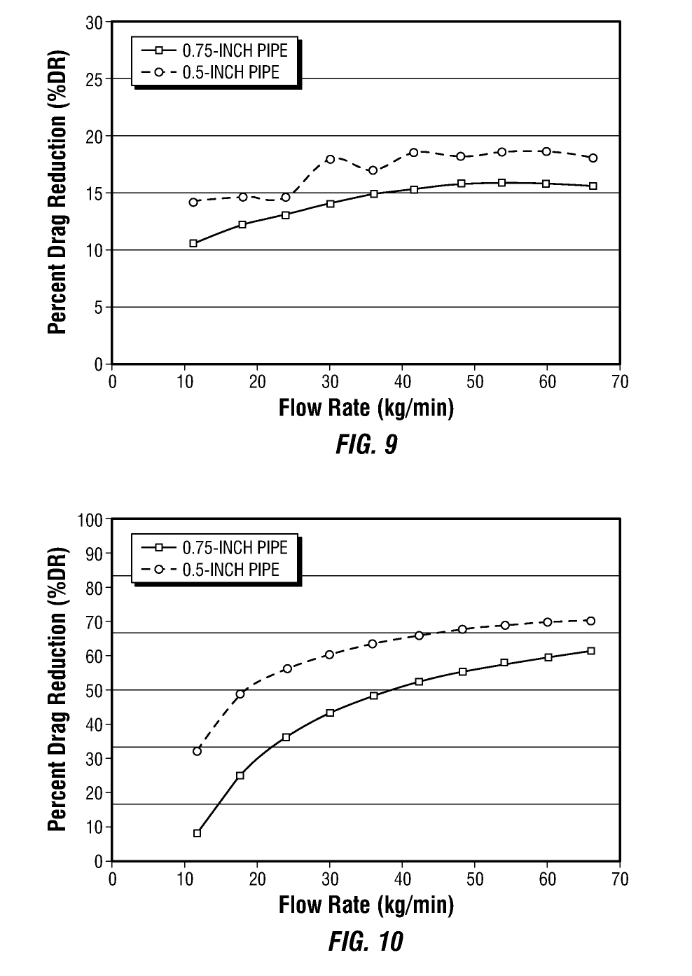

The examples were prepared and tested as described above. The cactus juice was added to the tap water at the (net) concentration of 1.4 wt %. The percent drag reduction (% DR) was measured as above and the results are shown in FIG. 9. As the data shows, the addition of 1.4 wt % of the cactus juice produced a % DR of about 10-20% in both 13 mm and 19 mm pipes.

### Comparative Example 10

The % DR effect of guar gum was measured with the same friction loop testing apparatus described above. Guar gum represents a comparative example. The guar gum was hydrated in the same tap water, with a loading of 0.06 wt %, consistent with recommended use of the same in the art. Friction loop tests were conducted as described above and the data is shown in FIG. 10. The % DR effect of the comparative 0.06 wt % of the guar gum in the tap water was at least qualitatively comparable with that of the aloe juice or okra juice. The aloe juice and okra juice showed an improvement at lower mass flow rates.

Accordingly, the data shows that a crude extract of plant based product comprising mucilage from various plant sources is suitable for use as a plant based product comprising mucilage according to friction loop testing.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A composition comprising from about 0.1 wt % to about 50 wt % of a plant based product comprising mucilage, wherein the mucilage is present in the composition at a concentration sufficient to achieve 10 to 80% drag reduction in a fluid, wherein % drag reduction is determined according to the formula:
$$\% DR = \frac{Δ Pwater - Δ Pfluid}{Δ Pwater} \cdot 100$$
wherein % drag reduction is represented as % DR;
ΔP water is the pressure differential between an inlet and an outlet of a friction loop pipe having water flowing there-through at a temperature and a flow rate; and wherein ΔP fluid is the pressure differential between the inlet and the outlet of the same friction loop pipe having the fluid comprising the composition flowing there-through at the same temperature and the same flow rate as the water.

2. The composition of claim 1, wherein the plant based product comprising mucilage comprises an extract, pressing, homogenate, or a combination thereof from at least one plant source.

3. The composition of claim 1, wherein the plant based product comprising mucilage comprises an extract, pressing, homogenate, or a combination thereof from Aloe Vera, Basella Alba, Cactus, Chondrus crispus, Dioscorea opposita, Drosera, Fenugreek, Flax seed, Kelp, Liquorice root, Marshmallow, Mullein, Okra, Parthenium, Pinguicula, Psyllium seed husks, Salvia hispanica seed, Ulmus rubra bark, or a combination thereof.

4. The composition of claim 1, comprising water or brine.

5. The composition of claim 1 further comprising a gas, a proppant particulate, a foaming agent, a gelling agent, a pH control agent, a breaker, an oxidizing breaker, a gel stabilizer, a fluid loss control additive, a clay stabilizer, a corrosion inhibitor, a crosslinking agent, a scale inhibitors, a catalyst, a surfactant, a preservative, a biocide, a thermal stabilizer, or a combination thereof.

6. The composition of claim 1, further comprising from about 1 ppm to 1 wt % each of a biocide, a preservative, a thermal stabilizer, or a combination thereof.

7. The composition of claim 6, wherein the biocide comprises a quaternary amine, an aldehyde, an alpha-omega di-aldehyde, or a combination thereof.

8. The composition of claim 6, wherein the thermal stabilizer comprises a metal from Groups 3-16 of the Periodic Table of the Elements.

9. The composition of claim 6, wherein the thermal stabilizer comprises a metal salt, oxide or coordination compound comprising a Group 3 to Group 12 metal of the Periodic Table of the Elements.

10. The composition of claim 6, wherein the thermal stabilizer comprises zirconium.

11. A well treatment fluid comprising the composition of claim 1.

12. A friction reducer fluid comprising the composition of claim 1.

13. A method of treating a wellbore comprising:
introducing a well treatment fluid into a wellbore penetrating a subterranean formation, wherein the well treatment fluid comprises from about 0.1 to about 50 wt % of a plant based product comprising mucilage.

14. The method of claim 13, wherein the well treatment fluid further comprises at least one additive selected from the group consisting of: a gas, a proppant particulate, a foaming agent, a gelling agent, a pH control agent, a breaker, an oxidizing breaker, a gel stabilizer, a fluid loss control additive, a clay stabilizer, a corrosion inhibitor, a crosslinking agent, a scale inhibitors, a catalyst, a surfactant, a preservative, a biocide, a thermal stabilizer, and a combination thereof.

15. A method of fracturing a subterranean formation comprising: providing a fracturing fluid comprising from about 0.1 to about 50 wt % of a plant based product comprising mucilage and introducing the fracturing fluid into the subterranean formation at a pressure sufficient to create or extend at least one fracture in the subterranean formation.

16. A method to produce a composition comprising:
combining a plant based product comprising mucilage with a solvent, in an amount sufficient to produce a composition comprising from about 0.1 wt % to about 50 wt % of the plant based product comprising mucilage, wherein the plant based product comprising mucilage comprises an extract, a pressing, a homogenate, or a combination thereof, from at least one plant source.

17. The method of claim 16, wherein the at least one plant source is selected from the group consisting of: Aloe Vera, Basella Alba, Cactus, Chondrus crispus, Dioscorea opposita, Drosera, Fenugreek, Flax seed, Kelp, Liquorice root, Marshmallow, Mullein, Okra, Parthenium, Pinguicula, Psyllium seed husks, Salvia hispanica seed, Ulmus rubra bark, and a combination thereof.

18. The method of claim 16, further comprising adding from about 1 ppm to about 1 wt % each of a biocide, a preservative, a thermal stabilizer, or a combination thereof to the composition, wherein the thermal stabilizer comprises a metal salt, oxide or coordination compound comprising a Group 3 to Group 12 metal of the Periodic Table of the Elements.

19. The method of claim 18, wherein the thermal stabilizer comprises zirconium.
